(19) United States
(12) Patent Application Publication
(10) Pub. No.: US 2016/0125719 A1
(43) Pub. Date: May 5, 2016

(54) RFID ENABLED MACHINE CONDITION INDICATOR AND ASSOCIATED SYSTEM FOR MONITORING A HEALTH STATUS OF A BEARING

(71) Applicants: Jonathan David Murphy, Friday Harbor, WA (US); Torsten Bark, San Diego, CA (US)

(72) Inventors: Jonathan David Murphy, Friday Harbor, WA (US); Torsten Bark, San Diego, CA (US)

(73) Assignee: AKTIEBOLAGET SKF, Goteborg (SE)

(21) Appl. No.: 14/529,820

(22) Filed: Oct. 31, 2014

(51) Int. Cl. G08B 21/18; F16C 41/00; G06K 7/10

(52) U.S. Cl. CPC G08B 21/187; G06K 7/10366; F16C 41/008

(57) ABSTRACT

A device and associated system for monitoring a health status of a bearing including a mobile data collector having a magnetic mounting pad coupled to a base of the mobile data collector; and an RFID enabled machine condition indicator coupled to the bearing through a machine bearing housing. The machine condition indicator provides a ferromagnetic contact body portion for housing the machine condition indicator, and an RFID tag having a unique identity and disposed within an unexposed portion of the ferromagnetic contact body. The RFID tag having an RFID antenna coupled to the RFID Tag for transmitting a unique identity of the RFID Tag to the data collection device. At least one sensor for sensing a velocity, an enveloped acceleration and a temperature reading of the bearing and at least one illuminating device for displaying the bearing health status according to input from one of the sensors.

### FIELD OF THE INVENTION

The present disclosure generally relates to a machine condition indicator affixed to a piece of rotating machinery. More particularly, the present disclosure relates to an RFID enabled machine condition indicator device and an associated system for monitoring a health status of a bearing affixed to a piece of rotating machinery.

### BACKGROUND OF THE INVENTION

Data collection is a complicated and expensive effort. The data collecting devices are expensive, too big to put in a pocket and require significant training to use. Data collection usually involves several button presses and complex screens per each measurement taken.

Data is often collected to monitor the operation of industrial machines. SKF model WMCD is one such data collection device. Such data collection may be used to diagnose problems, troubleshoot, trend operating changes, or otherwise record data points indicative of machine operation. A variety of data types may be collected, including temperature, vibration, and the like. The data collection may be continuous, i.e., using dedicated resources for individual machines or groups of machines. In other cases, data collection may be on-demand, for example, in routine checking and maintenance of the machines. In the latter case, mobile units may be provided that use sensors that are either permanently or temporarily coupled with the machine being measured.

The advantage of this invention combines a magnet mounting pad with a machine condition indicator (MCI) so that the valuable space on the bearing housing is still available to other condition monitoring sensors. Another advantage of this invention is to place the RFID tag in close proximity to the data collection device with a built in RFID reader. This makes reading the just one RFID tag ID possible, while ignoring any other RFID tags on the machine. Another advantage of this invention is the ability to automatically start a measurement when the instrument and magnet are placed on the Magnet Mounting Pad with RFID tag.

### SUMMARY OF THE INVENTION

Embodiments of the disclosure may provide an RFID enabled machine condition indicator for monitoring a health status of a bearing, the bearing disposed in a machine housing on a piece of rotating machinery, the machine condition indicator including: a magnet mounting pad having a ferromagnetic contact body portion for housing the machine condition indicator, a printed circuit assembly having a microcontroller for controlling the function of the machine condition indicator, an RFID tag having a unique identity, and disposed within an unexposed portion of the ferromagnetic contact body, the RFID tag including and an integrated circuit for storing and processing information, and a radio for modulating and demodulating a radio-frequency signal, a digital bus connecting the microcontroller to the RFID tag, at least one sensor for sensing at least one of a velocity, an enveloped acceleration and a temperature reading of the bearing, at least one illuminating device for displaying the health status of the bearing according to input from one of the at least one sensors, a battery for powering the machine condition indicator, wherein the microcontroller stores at least one of the sensed velocity, enveloped acceleration and the temperature values into a memory disposed within the RFID tag, an RFID antenna coupled to the RFID Tag, the antenna for transmitting a unique identity of the RFID Tag, the at least one of the sensed velocity, the enveloped acceleration and the temperature values, and wherein the memory is a dual access memory that enables data transfer via at least one of the RFID radio and the digital bus.

In a first aspect of the present invention the ferromagnetic contact body further includes a ferromagnetic washer that forms a top portion of the contact body and delimits the unexposed portion.

In a second aspect of the present invention the piece of rotating machinery is disposed within an industrial environment.

In third aspect of the present invention the at least one illuminating device further provides an indicating lamp for displaying the health status of the bearing.

In another aspect of the present invention the contact body further provides a disk shaped contact body having a flat bottom portion and an annular side portion.

In another aspect of the present invention the unexposed portion provides a well for mounting the RFID antenna and RFID tag in the top portion

In another aspect of the present invention the unique identity can be one of etched into the body and printed on a label and fixed to the body.

In another aspect of the present invention the mounting pad is affixed to the machine bearing housing by being one of epoxied and studded together.

In another aspect of the present invention the RFID tag is associated with a Point ID.

In another aspect of the present invention the Point ID may be preloaded into the RFID tag prior to shipment.

In another aspect of the present invention a function of waking up periodically to monitor the health status of the bearing is undertaken.

In another aspect of the present invention when an alarm condition is first identified via the periodic wake ups it is then verified by an algorithm.

In another aspect of the present invention the at least one of the alarm algorithm and alarm thresholds are modified via an RFID interface.

Embodiments of the disclosure may provide a system for monitoring a health status of a bearing, the system having a mobile data collector, the mobile data collector having a magnetic mounting pad coupled to a base of the mobile data collector; and an RFID enabled machine condition indicator coupled to the bearing through a machine bearing housing, the machine condition indicator having; a ferromagnetic contact body portion for housing the machine condition indicator, an RFID tag having a unique identity and disposed within an unexposed portion of the ferromagnetic contact body, the RFID tag including an integrated circuit for storing and processing information, a radio for modulating and demodulating a radio-frequency signal, an RFID antenna coupled to the RFID Tag, the antenna for transmitting a unique identity of the RFID Tag to the data collection device, and a printed circuit assembly having a microcontroller for controlling the machine condition indicator, a digital bus connecting the microcontroller to the RFID tag, a battery for powering the machine condition indicator, at least one sensor for sensing at least one of a velocity, an enveloped acceleration and a temperature reading of the bearing, and at least one illuminating device for displaying the health status of the bearing according to input from one of the at least one sensors, wherein the microcontroller stores at least one of the sensed velocity, enveloped acceleration and the temperature values into a memory disposed within the RFID tag, and wherein the memory is a dual access memory that enables data transfer via the RFID radio or via the digital bus, wherein the mobile data collector is configured to wirelessly retrieve stored data and send updated settings to and from the machine condition indicator, and wherein the RFID tag ID is used by the data collection device to retrieve POINT ID and POINT setting information and automatically initiate measurements that may include vibration and temperature measurements.

In another aspect of the present invention when the mounting magnet is centered and placed in alignment with the ferromagnetic contact body of the machine condition indicator, a rigid magnetic connection between the data collection device and machine condition indicator is formed.

In another aspect of the present invention an RFID reader built into the data collection device may be provided.

In a final aspect of the present invention the RFID tag is read automatically when the data collection device with its mounting magnet is placed onto the RFID Magnet Mounting Pad.

These and other advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, in which:

FIG. 1 is a perspective view of a typical assembly showing a hand held data collection device being applied to an RFID enabled machine condition indicator magnet mounting pad according to a preferred embodiment of the present invention;

FIG. 2 is an elevated perspective view of the RFID enabled machine condition indicator magnet mounting pad according to a preferred embodiment of the present invention;

FIG. 3 is a top view of the RFID enabled machine condition indicator magnet mounting pad according to a preferred embodiment of the present invention; and

FIG. 4 is a cross-sectional view of the RFID enabled machine condition indicator magnet mounting pad according to a preferred embodiment of the present invention.

Like reference numerals refer to like parts throughout the various views of the drawings.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Hence, specific dimensions and other physical characteristics relating to the embodiments disclosed herein are not to be considered as limiting, unless the claims expressly state otherwise. Also, it should be noted that a wire, electrical contact, electrical connector, etc., could be used as the form of electrical communication between internal device components.

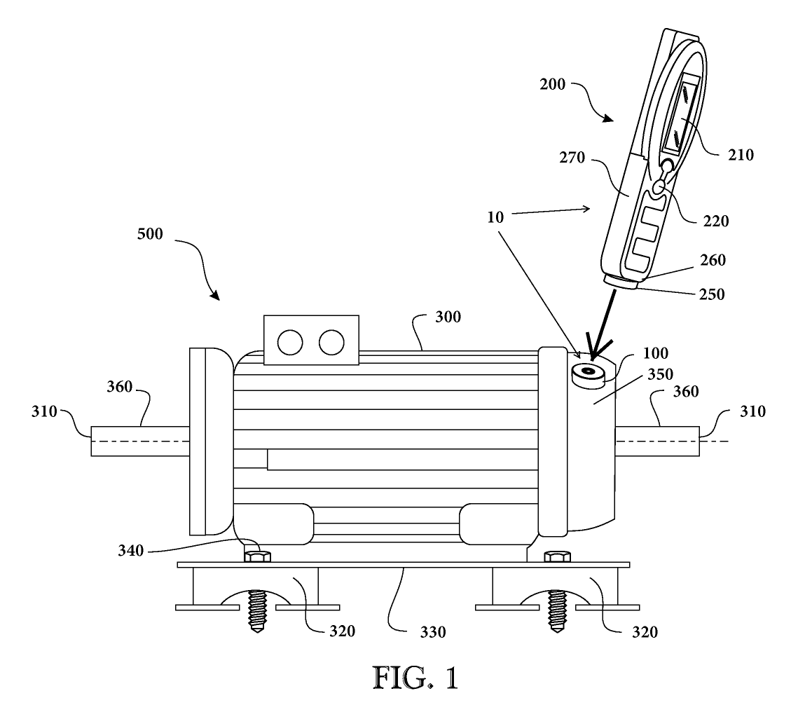

For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims.

There is shown in FIG. 1, a system 10 for monitoring a health status of a bearing (bearing not shown). The system 10 includes a mobile data collection device 200 and an RFID enabled machine condition indicator 100. The mobile data collection device 200 is depicted as being shown in the process of coming into contact with the RFID enabled machine condition indicator 100. The RFID enabled machine condition indicator 100 is affixed to a machine housing 350. The machine housing 350 is shown as being disposed on a piece of rotating equipment 300. An angularly downward pointing arrow illustrates the path. The combination of the mobile data collection device 200 and RFID enabled machine condition indicator 100 encompasses the system 10.

The system 10 and piece of rotating equipment 300 are typically disposed in a manufacturing or operating environment 500. Here, the piece of rotating equipment 300 is depicted as a motor 300, but could be any type of rotating equipment such as a fan, compressor, rotary positioner, conveyor, turbine, generator set, engine, pumps or the like. The machine housing 350 is preferably a machine bearing housing 350 that is in mechanical communication with the piece of rotating equipment 300.

In addition to the machine housing 350, the motor 300 may include two motor shafts 310 as shown. The motor shafts 310 provide coupling surfaces 360, whereby a piece of adjoining equipment, such as a generator or a turbine (not shown) for example, can be coupled thereto. The motor 300 further provides mounting components. In the present embodiment, they include a mounting plate 330, at least two mounting feet 320 and at least two mounting bolts 340. These mounting components allow the rotating equipment to be rigidly mounted to a solid base or floor (not shown) thus minimizing vibration and the affects it could have on measurements collected with the data collection device.

The mobile data collection device 200 integrally provides RFID reader circuitry 270 for reading a unique identity of the RFID tag and a magnetic mounting pad 250 electro-mechanically connected thereto. 15. Here, the magnetic mounting pad 250 and the mobile data collector 200 include a plurality of mating electrical contacts (not shown) disposed between the mobile data connector and magnet that facilitate electrical communication. A display 210 and start button 220 are also provided for basic operation of the device. The magnetic mounting pad 250 is typically screwed into a base 260 of the mobile data collector 200 so the aforementioned contacts line up. However, as long as a rigid electromechanical connection is made between the magnetic mounting pad 250 and the data collection device 200, the type of mounting therebetween is not critical to the present invention.

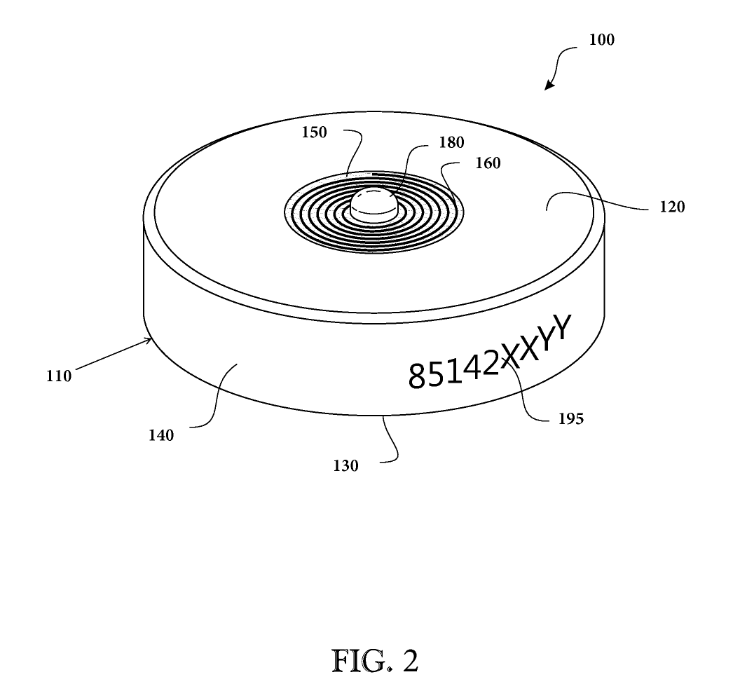

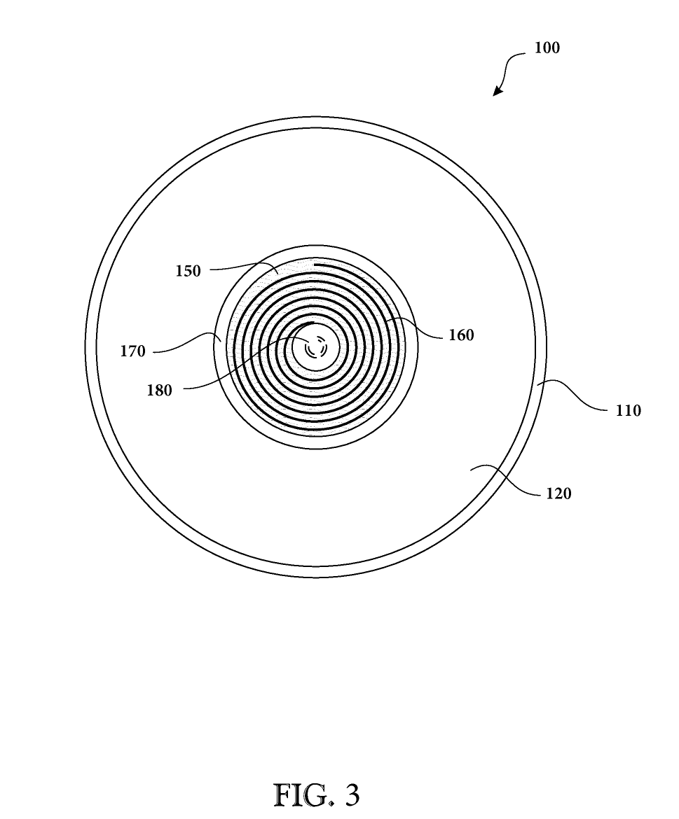

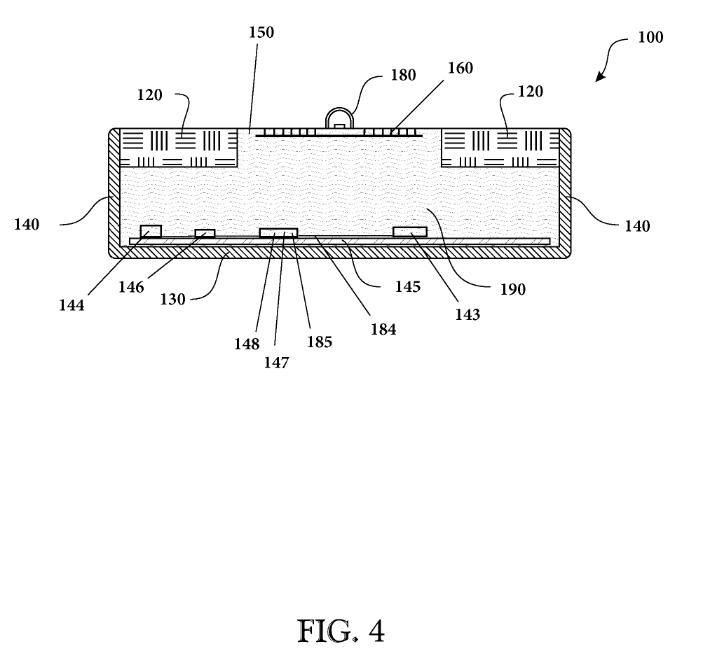

Referring now to FIGS. 1-4, there is shown a ferromagnetic contact body 110 for housing the RFID enabled machine condition indicator 100. The ferromagnetic contact body 110 provides a disk shaped contact body 110 having a flat bottom portion 130 and an annular side portion 140. An RFID tag 185 for transmitting a unique identity 195 of the RFID tag 185 is disposed on a printed circuit assembly 145. The printed circuit assembly 145 also includes a microcontroller 146 for controlling the function of the RFID enabled machine condition indicator 100. The RFID tag 185 includes an integrated circuit 147 for storing and processing information and a radio 148 for modulating and demodulating a radio-frequency signal.

The RFID tag 185 is disposed within an unexposed portion 190 of the ferromagnetic contact body 110. The ferromagnetic contact body 110 also provides a ferromagnetic washer 120 that forms a top portion 120 of the ferromagnetic contact body 110 and delimits the unexposed portion 190. The RFID enabled machine condition indicator 100 includes at least one sensor 143 for sensing at least one of a velocity, an enveloped acceleration and a temperature reading of the bearing and at least one illuminating device 180 for displaying the health status of the bearing according to input from one of the at least one sensors 143. The at least one illuminating device 180 may further provide an indicating lamp 180 for displaying the health status of the bearing. The RFID enabled machine condition indicator 100 provides a battery 144 for powering the machine condition indicator 100 and a digital bus 184 that connects the microcontroller 146 to the RFID tag 185, one of the at least one sensors 143, and the at least one illuminating device 180.

An RFID antenna 160 rests in the top portion 120 of an exposed portion 150 of the well 170. The RFID antenna 160 is sealed within the well 170 on assembly. On one hand, the antenna is typically epoxied in place. However, other methods of sealing components within housings, such as the use of a potting material or the like are contemplated in the present invention. The RFID tag 185 could be a custom designed sub-assembly or an off the shelf RFID tag assembly that is enclosed in the RFID enabled machine condition indicator 100.

Once the mobile data collector 200 with magnet mounting pad 250 is placed onto the RFID enabled machine condition indicator 100, the RFID tag reading system 10 is formed. To insure proper data transfer the mounting magnet pad 250 is optimally centered and placed in alignment with the ferromagnetic contact body of the machine condition indicator. This forms a rigid magnetic connection between the data collection device and machine condition indicator and establishes an RFID interface.

When the magnet mounting pad 250 and RFID enabled machine condition indicator 100 are magnetically united, the mobile data collector 200 automatically reads the unique RFID tag's 180 identity or Point ID 195, which is transmitted through the RFID antenna 160. In terms of the present invention, a Point ID is defined as a Measurement ID or Location ID. The mobile data collector is configured to wirelessly retrieve stored data and send updated settings to and from the machine condition indicator.

The mobile data collector 200 can also automatically read Point Settings and automatically initiate measurements that may include vibration and temperature measurements. The Point ID and Point Settings may be pre-set at the factory prior to shipment. In this case, the customer orders the tags prior to installation. The factory automatically creates the Points and links them to a customer login and RFID tag identifying info. By having everything preloaded at the factory, the process for the end user or customer is greatly simplified.

The RFID enabled machine condition indicator is programmed to wake up periodically to monitor the health status of the bearing. When an alarm condition is first identified via the periodic wake ups, it is then verified by an algorithm. When the alarm condition is verified by the algorithm, the at least one illuminating device for displaying the health status of the bearing is activated. The RFID enabled machine condition indicator alarm settings can be modified or updated as well. As such, at least one of the alarm algorithm and alarm thresholds can be modified by the mobile data collector via the RFID interface 270.

In one example, the mobile data collector 200 may include an inductor configured to energize passive RFID tags 180, when the mobile data collector 200 is brought into proximity therewith, and thereby read data such as the tag ID from the RFID tags 180. In other embodiments, the RFID tags 180 may be active RFID tags, which may transmit data to the mobile data collector 200 without requiring the mobile data collector 200 to provide the energizing.

The RFID tag may be a metal mount type. Further, the RFID antenna may either be a RFID spiral antenna or a wound inductor antenna. The unique tag identity 195 can either be etched into the body or printed on a label and fixed to the body 110. In addition, the mounting pad 100 can typically either be affixed to the machine bearing housing by being epoxied or studded together.

### LIST OF REFERENCE ELEMENTS

10 System for monitoring a health status of a bearing
110 Ferromagnetic contact body
120 Ferromagnetic washer/top portion
130 Flat bottom portion
140 Annular side portion
143 At least one sensor
144 Battery
145 Printed circuit assembly
146 Microcontroller
147 Integrated circuit
148 Radio
150 Exposed portion
160 RFID antenna
170 Well
180 At least one illuminating device/Indicating lamp
184 Digital bus
190 Unexposed portion
195 Unique identity
200 Mobile data collection device
210 Display
220 Start button
250 Magnetic mounting pad
260 Base of the mobile data collector
270 RFID reader circuitry
300 Piece of rotating equipment
310 Motor shaft(s)
320 At least two mounting feet
330 Mounting plate
340 At least two mounting bolts
350 Machine housing/Machine bearing housing
360 Coupling surfaces
500 Operating environment

1. An RFID enabled machine condition indicator for monitoring a health status of a bearing, the bearing disposed in a machine housing on a piece of rotating machinery, the machine condition indicator comprising:
a magnet mounting pad having a ferromagnetic contact body portion for housing the machine condition indicator,
a printed circuit assembly having a microcontroller for controlling the function of the machine condition indicator,
an RFID tag having a unique identity, and disposed within an unexposed portion of the ferromagnetic contact body, the RFID tag including an integrated circuit for storing and processing information, and a radio for modulating and demodulating a radio-frequency signal, a digital bus connecting the microcontroller to the RFID tag,
at least one sensor for sensing at least one of a velocity, an enveloped acceleration and a temperature reading of the bearing,
at least one illuminating device for displaying the health status of the bearing according to input from one of the at least one sensors,
a battery for powering the machine condition indicator, wherein
the microcontroller stores at least one of the sensed velocity, an acceleration, enveloped acceleration and the temperature values into a memory disposed within the RFID tag,
an RFID antenna coupled to the RFID Tag, the antenna for transmitting a unique identity of the RFID Tag, the at least one of the sensed velocity, the enveloped acceleration and the temperature values, and wherein
the memory is a dual access memory that enables data transfer via at least one of the RFID radio and the digital bus.

2. The RFID enabled machine condition indicator according to claim 1, wherein the ferromagnetic contact body further includes a ferromagnetic washer that forms a top portion of the contact body and delimits the unexposed portion.

3. The RFID enabled machine condition indicator according to claim 1, wherein the piece of rotating machinery is disposed within an industrial environment.

4. The RFID enabled machine condition indicator according to claim 1, wherein the at least one illuminating device further comprises an indicating lamp for displaying the health status of the bearing.

5. The RFID enabled machine condition indicator according to claim 1, wherein the contact body further provides a disk shaped contact body having a flat bottom portion and an annular side portion.

6. The RFID enabled machine condition indicator according to claim 2, wherein the unexposed portion provides a well for mounting the RFID antenna in the top portion.

7. The RFID enabled machine condition indicator according to claim 1, wherein the unique identity of the RFID tag can be one of etched into the body and printed on a label and fixed to the body.

8. The RFID enabled machine condition indicator according to claim 1, wherein the mounting pad is affixed to the machine bearing housing by being one of epoxied and studded together.

9. The RFID enabled machine condition indicator according to claim 1, wherein the machine housing further comprises a machine bearing housing.

10. The RFID enabled machine condition indicator according to claim 1, wherein the RFID tag is associated with a Point ID.

11. The RFID enabled machine condition indicator according to claim 10, wherein the Point ID may be preloaded into the RFID tag prior to shipment.

12. The RFID enabled machine condition indicator according to claim 1, further comprising waking up periodically to monitor the health status of the bearing.

13. The RFID enabled machine condition indicator according to claim 12, wherein when an alarm condition is first identified via the periodic wake ups it is then verified by an algorithm.

14. The RFID enabled machine condition indicator according to claim 13, wherein the at least one illuminating device for displaying the health status of the bearing is activated when the alarm condition is verified.

15. The RFID enabled machine condition indicator according to claim 13, wherein at least one of the alarm algorithm and alarm thresholds are modified via an RFID interface.

16. A system for monitoring a health status of a bearing, the system comprising:
a mobile data collector, the mobile data collector having a magnetic mounting pad coupled to a base of the mobile data collector; and
an RFID enabled machine condition indicator coupled to the bearing through a machine bearing housing, the machine condition indicator having;
a ferromagnetic contact body portion for housing the machine condition indicator,
an RFID tag having a unique identity and disposed within an unexposed portion of the ferromagnetic contact body, the RFID tag including an integrated circuit for storing and processing information,
a radio for modulating and demodulating a radio-frequency signal,
an RFID antenna coupled to the RFID Tag, the antenna for transmitting a unique identity of the RFID Tag to the data collection device, and
a printed circuit assembly having a microcontroller for controlling the machine condition indicator, a digital bus connecting the microcontroller to the RFID tag,
a battery for powering the machine condition indicator,
at least one sensor for sensing at least one of a velocity, an acceleration, an enveloped acceleration and a temperature reading of the bearing, and at least one illuminating device for displaying the health status of the bearing according to input from one of the at least one sensors, wherein
the microcontroller stores at least one of the sensed velocity, enveloped acceleration and the temperature values into a memory disposed within the RFID tag, and wherein the memory is a dual access memory that enables data transfer via the RFID radio or via the digital bus, wherein
the mobile data collector is configured to wirelessly retrieve stored data and send updated settings to and from the machine condition indicator, and wherein
the RFID tag ID is used by the mobile data collector to retrieve POINT ID and POINT setting information and automatically initiate measurements that may include vibration and temperature measurements.

17. The system for monitoring a health status of a bearing according to claim 16, wherein when the mounting magnet is centered and placed in alignment with the ferromagnetic contact body of the machine condition indicator, a rigid magnetic connection between the data collection device and machine condition indicator is formed.

18. The system for monitoring a health status of a bearing according to claim 16, further comprising an RFID reader built into the data collection device.

19. The system for monitoring a health status of a bearing according to claim 18, wherein the RFID tag is read automatically when the data collection device with its mounting magnet is placed onto the RFID Magnet Mounting Pad.
